(19) United States
(12) Patent Application Publication
(10) Pub. No.: US 2008/0205239 A1
(43) Pub. Date: Aug. 28, 2008

(54) APPARATUS AND METHOD FOR RECORDING/REPRODUCING DATA ON/FROM HOLOGRAPHIC STORAGE MEDIUM

(75) Inventor: TAEK-SEONG JEONG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/957,656

(22) Filed: Dec. 17, 2007

(30) Foreign Application Priority Data
Feb. 22, 2007 (KR) 2007-18092

(51) Int. Cl. G11B 7/00

(52) U.S. Cl. 369/103

(57) ABSTRACT

An apparatus and a method for recording/reproducing data on a holographic storage medium using temperature information of the holographic storage medium. The apparatus includes: a light processing unit to record the data on the holographic storage medium or to reproduce the data from the holographic storage medium; and a control unit to control the light processing unit, such that the data is recorded on the holographic storage medium, using a recording wavelength determined according to a temperature of the holographic storage medium or an ambient temperature thereof.

### CROSS-REFERENCE TO RELATED APPLICATION

This application claims the benefit of Korean Application No. 2007-18092, filed Feb. 22, 2007, in the Korean Intellectual Property Office, the disclosure of which is incorporated herein by reference.

### BACKGROUND OF THE INVENTION

1. Field of the Invention

Aspects of the present invention relate to a holographic storage medium, and more particularly, to an apparatus and method for recording/reproducing data.

2. Description of the Related Art

In optical holography, the volume of a recording medium is used to store data, instead of just the surface. The interference between a signal beam and a reference beam produces interference gratings, which are referred to as data pages, in the recording media. The interference gratings are superimposed, by changing the optical characteristics of the reference beam. This process is referred to as multiplexing. When reading data, a single reference beam is made to be incident into the recording medium, under the same conditions as for data recording, to generate a diffraction beam that displays the stored data pages. A detection array detects the diffraction beam, and extracts stored data bits, by measuring intensity patterns. The data pages contain a large number of data bits or pixels. Multiple data pages can be superimposed in the same volume of the recording medium, so that the data storage capacity of the recording medium can be increased.

FlGS. 1A and 1B illustrate optical holographic recording and reproduction of data. Holograms are recorded on a storage medium, using a signal beam S that includes data and a reference beam R. Referring to FIG. 1A, when recording holograms, the reference beam R and the signal beam S, which are coherent, are combined to generate an interference pattern on the storage medium. Referring to FIG. 1B, when reproducing holograms, the original reference beam R is irradiated onto the interference patterns (holograms) stored in the storage medium, and the signal beam S is output, due to diffraction caused by the holograms. If a different reference beam is used to reproduce the holograms, which has a different angle of incidence and/or wavelength than the original reference beam R, the capacity and/or direction of a reproduced signal beam differs from the capacity and/or direction of the original signal beam S. Generally, the greater the difference between the original and different reference beams, the more the beam capacity is reduced. The reduction follows the form of a sinc function.

FIG. 2A illustrates optical holography gratings recorded with two plane waves. FIG. 2B illustrates the variation of the angle of a reproduced beam, and the reduction in diffraction efficiency thereof, when the irradiation conditions in which a reference beam records data are different from the irradiation conditions when a reference beam reproduces the data. Referring to FIGS. 2A and 2B, \vec{K}_{S} and \vec{K}_{R} denote wave vectors of a signal beam and a reference beam, respectively \vec{K} denotes a vector of the grating formed by the interference of the signal beam and the reference beam, L denotes the thickness of a storage medium, and [symbol] denotes a unit vector, which is perpendicular to the storage medium.

Referring to FIG. 2B, dotted and solid lines indicate the beams when recording and reproducing data, respectively. The diffraction efficiency is generally reduced, since each vector does not satisfy the Bragg condition (2d sinθ=nλ). In the Bragg condition, a high diffraction efficiency results when holograms are reproduced using a reference beam that has the same characteristics as the beam used to record the holograms. When reading data, if the wave vector of the reference beam substantially differs from the wave vector of the reference beam used to record the data, the diffraction efficiency is remarkably reduced. The wave vector of the reference beam can be varied, by changing the incident angle and/or the wavelength of the reference beam.

As shown in FIG. 3, the above phenomenon can be used such that several data pages can be superimposed and recorded in the same volume of a holographic storage medium. A different reference beam is used to record each data page, in the holographic storage medium. The recorded data pages have different intensities when reproduced, according to the angle of incidence of each of the reference beams. Therefore, when reproducing the pages, it is possible to identify the pages, by controlling the conditions under which the reference beam irradiates the storage medium.

If the temperature of the holographic storage medium, when reproducing data, is different from the temperature of the holographic storage medium when data was recorded, the volume of the holographic storage medium expands and/or the refractive index thereof changes, which varies the size and direction of the recorded grating vectors. Therefore, the temperature induced changes in the reproduction conditions, with respect to the recording conditions, often result in a data reproduction failure.

In more detail, when data is conventionally recorded on a holographic storage medium, at a regular wavelength, the temperature of the holographic storage medium is changed to be suitable for the reproduction of data. For example, if a beam source has a variable range of between −4 nm and +4 nm, and data is recorded at a temperature of 10° C., the data can be reproduced at a temperature of between 10° C. and 30° C. When data is recorded at a temperature of 40° C., the data can be reproduced at a temperature of between 20° C. and 60° C. Accordingly, the holographic storage medium does not maintain a constant temperature range suitable for the reproduction of all of the data.

### SUMMARY OF THE INVENTION

Aspects of the present invention provide an apparatus and method for recording/reproducing data, which can be reproduced over a constant temperature range. The constant temperature range allows for consistent reproduction of the data, from a holographic storage medium, thereby increasing the reproduction reliability of the holographic storage medium.

According to aspects of the present invention, there is provided an apparatus for recording data on a holographic storage medium, in which holograms are recorded by an interference between a signal beam and a reference beam. The apparatus comprises: a light processing unit to record the data on the holographic storage medium and/or to reproduce the data from the holographic storage medium; and a control unit to control the light processing unit, such that the data is recorded on the holographic storage medium using a recording. wavelength, determined according to a temperature of the holographic storage medium and/or an ambient temperature thereof.

The control unit may comprise: a temperature measuring unit to measure the temperature of the holographic storage medium and/or the ambient temperature thereof; a recording wavelength calculator to calculate a recording wavelength corresponding to the measured temperature; and a light source control unit to control the light source of the light processing unit, according to the calculated recording wavelength. The control unit may control the light processing unit, such that the temperature information of the holographic storage medium, the ambient temperature thereof and/or the recording wavelength information thereof are recorded on a predetermined area of the holographic storage medium.

According to another aspect of the present invention, there is provided an apparatus for reproducing data from a holographic storage medium, the apparatus comprising: a light processing unit to record the data on the holographic storage medium and/or to reproduce the data from the holographic storage medium; and a control unit to control the light processing unit, such that temperature information of the holographic storage medium, an ambient temperature thereof and/or information on a recording wavelength, are read from the holographic storage medium, after the data has been recorded on the holographic storage medium. The control unit can further control the light processing unit, such that a reproducing wavelength is determined, using the read information, and the data is read from the holographic storage medium using the determined reproducing wavelength.

According to another aspect of the present invention, there is provided a method of recording data on a holographic storage medium, the method comprising: recording data on the holographic storage medium using a recording wavelength, determined according to a temperature of the holographic storage medium and/or an ambient temperature thereof. The recording of data may comprise: measuring the temperature of the holographic storage medium and/or the ambient temperature thereof; calculating the recording wavelength corresponding to the measured temperature; and controlling the light source of the light processing unit, according to the calculated recording wavelength. The recording of data may further comprise: recording information on the temperature of the holographic storage medium, the ambient temperature thereof, and/or the information on the recording wavelength thereof, on a predetermined area of the holographic storage medium.

According to another aspect of the present invention, there is provided a method of reproducing data from a holographic storage medium, the method comprising: reading information on a temperature of the holographic storage medium, an ambient temperature thereof, and/or information on a recording wavelength, from the holographic storage medium; determining a reproducing wavelength using the read data; and reading the data from the holographic storage medium, using the determined reproducing wavelength.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate optical holographic recording and reproduction of data;

FIG. 2A illustrates gratings recorded with two plane waves;

FIG. 2B illustrates variations in an angle of a reproduced beam and a reduction in the diffraction efficiency thereof, when a reference beam does not satisfy certain conditions when reproducing data;

FIG. 3 illustrates multiple superimposed data pages;

FIG. 4 is a diagram of a hologram recording/reproducing apparatus according to an embodiment of the present invention;

FIG. 5 is a block diagram of a control unit illustrated in FIG. 4, when data is recorded;

FIG. 6 is a flowchart of a method of recording data on a holographic storage medium, according to an embodiment of the present invention; and

FIG. 7 is a flowchart of a method of reproducing data from a holographic storage medium, according to an embodiment of the present invention.

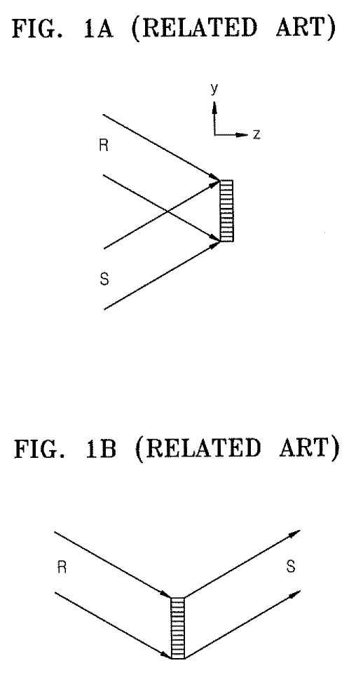

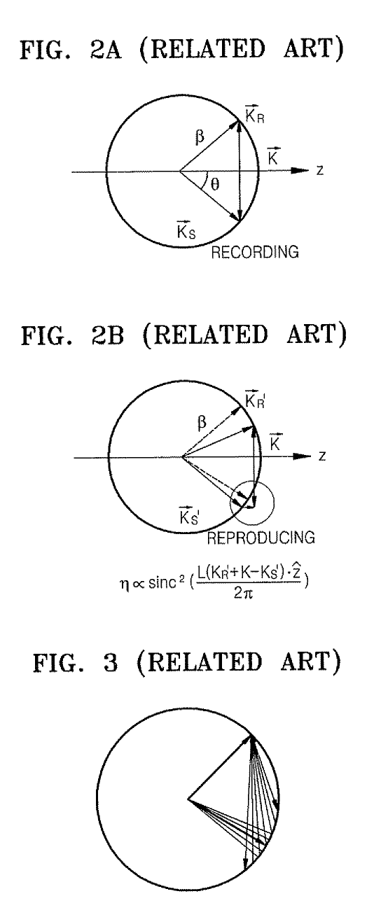

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Holograms can be recorded on a holographic storage medium using a reference beam and a signal beam. Interference between the two beams creates a plurality of gratings, which make up each hologram. The refractive properties (refractive direction and size) of the gratings vary according to changes in the temperature of the holographic storage medium. Therefore, the intensity of a signal beam, produced when the reference beam is directed to the gratings, can be diminished due to temperature changes. The change in the intensity of the signal beam can be predicted using the Bragg condition.

To address a drop of the intensity of a signal beam, the angle and/or wavelength of the first reference beam can be altered, in order to satisfy the Bragg condition, as it applies to the temperature varied characteristics of the gratings. In more detail, the angles and sizes of vectors, produced by refraction of a reference beam on the gratings, which are not within the changed Bragg condition, can be changed to satisfy the temperature changed Bragg condition. However, applying such changes to the production of a signal beam, which satisfies the Bragg condition based on the varied refractive properties, is often problematic.

The signal beam is a set of beams having a variety of angles, because the signal beam is produced from gratings having various angles and sizes. The refractive properties of the gratings are altered by changes in the temperature of the holographic storage medium. The amount each grating is altered varies according to the size and direction thereof. These factors make it difficult to select a value to compensate for the reduction in the intensity of the signal beam. Therefore, when reproducing data, a part of a data page may satisfy the Bragg condition while another part thereof may not. It is therefore, possible to reproduce only a portion of a data page, by changing the wavelength and/or the angle of the reference beam.

To establish optimized reproduction conditions, the following equation is established,

$$\frac{{K}_{g}}{k} = 2 sin ( {θ}_{r} - φ )$$

In the above equation, K_{g} denotes the size of each grating recorded on the holographic storage medium, φ denotes the direction of each grating, and θᵣ denotes the angle of the reference beam. In the equation, a one-dimensional convergence is possible if an initial value of the wavelength, and/or angle of the reference beam, changes only slightly. Therefore, the wavelength and angle of the reference beam should have a linear relationship, due to the gratings, in order to optimally reproduce data. This type of relation equation varies according to the size and angle of each grating.

When recording data, to be reproduced as a full page, it is useful to calculate the angle of the signal beam, i.e., the relation equation according to each grating, and find the wavelength and angle of a reference beam capable of reproducing all of the gratings. In this regard, the optimal reproduction wavelength, based on the above relation, varies by about 0.2 nm for each 1° C. change in the temperature of the holographic storage medium. This variation is due to changes in the expansion and refraction of the holographic storage medium, based on the temperature of the holographic storage medium.

Therefore, it is generally possible to compensate for a change in the recording temperature, between about ±(variable wavelength range/0.2)° C. For example, if the variable wavelength range is between ±4 nm, the recording temperature can be compensated for over a range of ±20° C.

To assist the compensation when recording data, the temperature of the holographic storage medium is measured, and the recording wavelength is varied accordingly, thereby making a constant reproduction temperature range. In detail, while recording data, if the recording temperature of the holographic storage medium is 10° C. in one instance and 40° C. in another instance, the recording wavelength for each instance is varied according to the temperature, in order to make the constant reproduction temperature range. The recording wavelength can be varied within the variable wavelength range of a beam source.

FIG. 4 is a diagram of a hologram recording/reproducing apparatus according to an embodiment of the present invention. Referring to FIG. 4, the hologram recording/reproducing apparatus includes a light processing unit 410 onto which a holographic storage medium 400 is loaded, and a control unit 500, which controls the light processing unit 410 to record data on the holographic storage medium 400 or reproduce the data from the holographic storage medium 400. The light processing unit 410 includes a light source 41 1, a beam splitter 412, a first mirror 413, a spatial light modulator (SLM) 414, a first lens 415, a second mirror 416, a second lens 417, a third lens 418 and a detection unit 419.

The control unit 500 controls the light processing unit 410, generates data pages containing the data, transmits the data pages to the light processing unit 410, and processes signals reproduced by the light processing unit 410. In particular, the control unit 500 uses a recording wavelength, determined according to the temperature of the holographic storage medium 400 or the ambient temperature thereof, to control the light source 411, such that data is recorded on the holographic storage medium 400. The light source 411 can be a laser beam source.

The control unit 500 can also record, on the holographic storage medium 400, information on the temperature or the recording wavelength that was used to record the data. After the recording, if a reproduced signal is not sufficiently produced, when reproducing the data from the holographic storage medium 400, the information on the temperature or the recording wavelength can be used to establish a more reliable wavelength for a light source.

When data is recorded on the holographic storage medium 400, a laser beam is output from the light source 41 1, to determine the recording wavelength according to the temperature of the holographic storage medium 400 or the ambient temperature thereof. The laser beam is divided by the beam splitter 412 into a reference beam R and a signal beam S. The signal beam S is incident on the SLM 414, which displays the recorded data and spatially amplitude-modulates the incident beam. The modulated signal beam S is focused into the holographic storage medium 400, by the first lens 415. Meanwhile, the reference beam R is reflected by the second mirror 416 and directed onto the holographic storage medium 400 by the second lens 417. Accordingly, the superimposed signal beam S and reference beam R form an interference pattern, which is recorded as a grating pattern on the holographic storage medium 400.

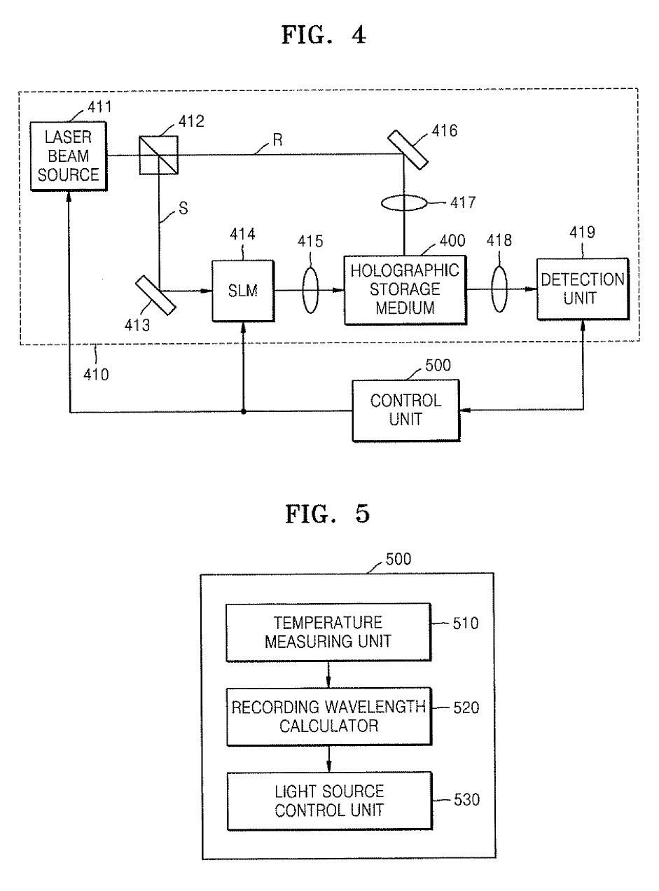

Referring to FIG. 5, the constitution of the control unit 500, when recording the data on the holographic storage medium 400, will now be described in more detail. The control unit 500 includes a temperature measuring unit 510, a recording wavelength calculator 520, and a light source control unit 530. The temperature measuring unit 510 measures temperature information relating to the holographic storage medium 400. The temperature information can comprise the temperature of the holographic storage medium 400 and/or the ambient temperature thereof. The ambient temperature, as used herein, refers to the temperature of the environment surrounding or directly adjacent to, the holographic storage medium. The recording wavelength calculator 520 calculates a recording wavelength corresponding to the measured temperature. The light source control unit 530 controls the light source 411, of the light processing unit 410, to produce a reference beam, according to the calculated recording wavelength.

When the data recorded on the holographic storage medium 400 is reproduced, a light beam, approximately identical to a reference beam that was used for recording the data, is applied to the holographic storage medium 400, and the data is reproduced as a diffraction beam corresponding to the interference pattern recorded on the holographic storage medium 400. The diffraction beam is focused onto the detection unit 419 by the third lens 418. The detection unit 419 can comprise a charge-coupled device (CCD) a complementary metal-oxide-semiconductor (CMOS), or the like. A reproduction signal is output from the detection unit 419 to the control unit 500.

In particular, the control unit 500 controls the light processing unit 410, such that the temperature information relating to the temperature or the ambient temperature of the holographic storage medium 400, when the data was recorded, and/or information on the recording wavelength of the reference beam that was used to record the data on the holographic storage medium 400, is read from a predetermined area of the holographic storage medium 400. The control unit 500 controls the light source 411, such that a reproducing wavelength is determined using the read information, and the data is read from the holographic storage medium 400 using a reference beam having the determined reproducing wavelength.

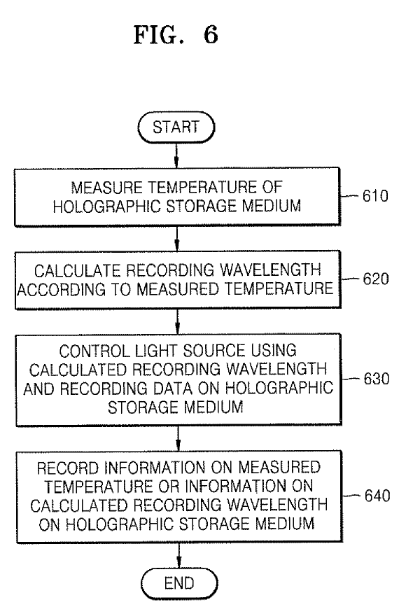

FIG. 6 is a flowchart of a method of recording data in the form of holograms on a holographic storage medium, according to an embodiment of the present invention. Referring to FIG. 6, temperature information relating to the holographic storage medium is measured (Operation 610). The temperature information can comprise a temperature of the holographic storage medium and/or an ambient temperature thereof. A recording wavelength is calculated according to the measured temperature information (Operation 620). A light source is controlled using the calculated recording wavelength, and data is recorded on the holographic storage medium (Operation 630). The temperature information and/or recording wavelength information are recorded on the holographic storage medium (Operation 640). Operations 610-630 can be repeated for each hologram stored on the holographic storage medium, or can be repeated at predetermined time intervals.

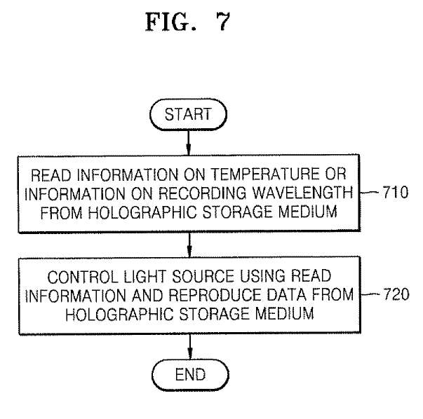

FIG. 7 is a flowchart of a method of reproducing data from a holographic storage medium, according to an embodiment of the present invention. Referring to FIG. 7, temperature information and/or recording wavelength information are read from the holographic storage medium (Operation 710). A light source is controlled to produce a reference beam, using the read information, and data is reproduced from the holographic storage medium using the reference beam (Operation 720).

Aspects of the present invention can also be embodied as a computer readable code in a computer readable recording medium. The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, optical data storage devices, carrier waves, and the like. The computer readable recording medium can also be distributed on network coupled computer systems, so that the computer readable code is stored and executed in a distributed fashion. Also, functional programs, code, and code segments for accomplishing the aspects of the present invention can be easily construed by programmers skilled in the art to which the present invention pertains.

The present invention can maintain a constant reproduction temperature range, regardless of a recording temperature of a holographic storage medium, when data is reproduced from the holographic storage medium.

Although a few embodiments of the present invention have been shown and described, it would be appreciated by those skilled in the art that changes may be made in this embodiment without departing from the principles and spirit of the invention, the scope of which is defined in the claims and their equivalents. As used herein, when an item is said to “comprise at least one of”, and is followed by one or more exemplary components, the item can comprise one of the exemplary items, all of the exemplary items, or any combination of the exemplary items.

What is claimed is:

1. An apparatus to record data on a holographic storage medium in the form of holograms, the apparatus comprising:
a light processing unit to record the data on the holographic storage medium using a signal beam and a reference beam; and
a control unit to control the light processing unit and to calculate a recording wavelength for the reference beam according to temperature information of the holographic storage medium.

2. The apparatus of claim 1, wherein:
the light processing unit comprises a light source to produced the reference beam; and
the control unit comprises:
a temperature measuring unit to measure a temperature of the holographic storage medium or an ambient temperature thereof;
a recording wavelength calculator to calculate the recording wavelength using the temperature of the holographic storage medium or the ambient temperature thereof; and
a light source control unit to set the wavelength of the reference beam produced by the light source to the calculated recording wavelength.

3. The apparatus of claim 1, wherein the control unit further controls the light processing unit to record at least one of the temperature information, and the recording wavelength on an area of the holographic storage medium.

4. An apparatus to reproduce data stored as holograms in a holographic storage medium, the apparatus comprising:
a light processing unit to read reference information from the holographic storage medium and to reproduce the data from the holographic storage medium; and
a control unit to calculate a reference wavelength using the reference information and to control the light processing unit to read the data by producing a reproduction reference beam having the reference wavelength,
wherein the reference information comprises at least one of temperature information relating to the temperature of the holographic storage medium and wavelength information relating to the wavelength of a reference beam used to record the holograms.

5. A method of recording data on a holographic storage medium in the form of holograms, the method comprising:
detecting temperature information relating to the holographic storage medium; and
recording the data on the holographic storage medium using a reference beam having a recording wavelength set according to the temperature information.

6. The method of claim 5, wherein the detecting of the temperature information comprises:
measuring at least one of a temperature of the holographic storage medium and an ambient temperature thereof; and
calculating the recording wavelength using the temperature information.

7. The method of claim 5, further comprising:
recording the temperature information on a predetermined area of the holographic storage medium.

8. A method of reproducing data stored as holograms in a holographic storage medium, the method comprising:
reading temperature information or recording wavelength information from the holographic storage medium;
determining a reproducing wavelength using the temperature information or the recording wavelength information, and
reading the data from the holographic storage medium using a reproducing reference beam having the reproducing wavelength.

9. The apparatus of claim 1, wherein the temperature information comprises a temperature of the holographic storage medium or an ambient temperature thereof when the data was recorded.

10. The apparatus of claim 4, wherein the temperature information comprises a temperature of the holographic storage medium or an ambient temperature thereof, when the data was recorded.

11. The method of claim 5, wherein the recording wavelength is varied according to the temperature information for each recorded hologram in order to produce a constant reproduction temperature range for all of the holograms.

12. The method of claim 8, wherein the temperature information comprises a temperature of the holographic storage medium or an ambient temperature thereof, when the data was recorded.

13. An apparatus to record and reproduce data on a holographic storage medium in the form of holograms, the apparatus comprising:
a light processing unit to record the data on the holographic storage medium using a signal beam and a reference beam, to read reference information from the holographic storage medium, and reproduce the data from the holographic storage medium; and
a control unit to control the light processing unit, to calculate a recording wavelength for the reference beam according to temperature information of the holographic storage medium, to calculate a reference wavelength using the reference information, and to control the light processing unit to read the data by producing a reproduction reference beam having the reference wavelength,
wherein the reference information comprises at least one of temperature information relating to the temperature of the holographic storage medium and wavelength information relating to the wavelength of a reference beam used to record the holograms.

14. The apparatus of claim 13, wherein the control unit further controls the light processing unit to record at least one of the temperature information, and the recording wavelength on an area of the holographic storage medium.

15. The apparatus of claim 13, wherein the temperature information comprises a temperature of the holographic storage medium or an ambient temperature thereof, when the data was recorded.
